(19) United States
(12) Patent Application Publication
(10) Pub. No.: US 2024/0382939 A1
(43) Pub. Date: Nov. 21, 2024

(54) Degradation Method of PFAS

(71) Applicant: Suzhou University of Science and Technology, Suzhou (CN)

(72) Inventors: Haoting TIAN, Suzhou (CN); Xiaohui YANG, Suzhou (CN)

(73) Assignee: Suzhou University of Science and Technology, Suzhou (CN)

(21) Appl. No.: 18/656,326

(22) Filed: May 6, 2024

(30) Foreign Application Priority Data
May 15, 2023 (CN) 2023105449567

(51) Int. Cl. B01J 31/06; A62D 3/176; A62D 3/37; A62D 101/22; B01J 35/39; B01J 37/02; B01J 37/03; B01J 37/04; B01J 37/06; C08G 61/12

(52) U.S. Cl. CPC B01J 31/06; A62D 3/176; A62D 3/37; B01J 35/39; B01J 37/0236; B01J 37/031; B01J 37/04; B01J 37/06; C08G 61/124; A62D 2101/22; B01J 2231/005; B01J 2531/002; C08G 2261/11; C08G 2261/3241; C08G 2261/43

(57) ABSTRACT

The present disclosure relates to a degradation method of a perfluoroalkyl substance (PFAS). The degradation method includes the following steps: polymerizing indole to synthesize pind; and mixing synthesized pind with the PFAS to form a mixed solution, and illuminating the formed mixed solution to allow pind to generate hydrated electrons (e_{aq}⁻) for degrading the PFAS. In the degradation method of the present disclosure, indole with a high yield of hydrated electrons is polymerized to generate pind, and pind is used as a precursor for the generation of the hydrated electrons to increase the stability of a molecular structure of pind through a highly conjugated structure formed after polymerization, thereby achieving the purpose of continuously generating the hydrated electrons under ultraviolet irradiation and effectively degrading PFASs, which is of great significance for addressing the environmental pollution problem of PFASs.

### CROSS-REFERENCE TO RELATED APPLICATIONS

The application claims priority to Chinese patent application No. 2023105449567, filed on May 15, 2023, the entire contents of which are incorporated herein by reference.

### TECHNICAL FIELD

The present disclosure relates to a degradation method of a perfluoroalkyl substance (PFAS).

### BACKGROUND

PFASs are one of the new contaminants that have received most attention in recent years. PFASs have excellent heat resistance and chemical stability and are widely used in various industrial and civil fields. Perfluorooctanoic acid (PFOA) and perfluorooctane sulphonate (PFOS) are the two most typical PFASs. These substances are very stable, difficult to degrade naturally in the environment, and are not metabolized in animals, so they may be transported over long distances worldwide and have bioaccumulation and amplification in the food web, posing a serious threat to ecosystems and human health. The C—F bond in the PFAS molecule has strong polarity and high bond energy, so it is very difficult to be hydrolyzed, photolyzed, oxidized, and reduced. Therefore, conventional water treatment technologies, such as ozone oxidation, activated sludge, anaerobic digestion, chlorination, and Fenton oxidation cannot degrade the C—F bond. Activated carbon adsorption, ion exchange, and reverse osmosis may remove PFASs from water, but the PFASs still need to be completely eliminated by subsequent methods to avoid secondary pollution. A hydrated electron (e_{aq}⁻) reduction method has unique advantages in degrading PFASs, such as high efficiency, universality, and thorough defluorination. However, the hydrated electron reduction method still has limitations. Since the precursor substance is changed in nature and structure after photoionization and hydrated electron generation under ultraviolet irradiation, hydrated electrons can no longer be generated. Therefore, the precursor needs to be continuously added in the reaction, and the consumption is large. Therefore, the exploration of precursor substances that can continuously generate hydrated electrons and are structurally stable themselves is of great significance for the development of methods for efficiently degrading PFASs.

### SUMMARY

The present disclosure provides a degradation method of a PFAS to solve the problem of low degradation and defluorination efficiency of existing methods for degrading a PFAS.

According to a first aspect of the present disclosure, a degradation method of a PFAS is provided, including the following steps:

polymerizing indole to synthesize pind; and

mixing synthesized pind with the PFAS to form a mixed solution, and illuminating the formed mixed solution to allow pind to generate hydrated electrons for degrading the PFAS.

The principle of the present disclosure is as follows. A redox potential of the hydrated electron is −2.9 V, which may effectively attack the C—F bond when degrading PFASs, and achieve C—F bond breakage with a high defluorination rate, having a good application prospect. A common method for generating hydrated electrons is ultraviolet irradiation with iodine ions (I⁻) or sulfite ions (SO₃²⁻). The inventors found in previous studies that indole may also generate hydrated electrons under ultraviolet irradiation and may be used for degrading PFASs. However, since monomers of the above substances are changed in nature and structure after generating one hydrated electron, hydrated electrons can no longer be generated. Thus, a yield of the hydrated electrons cannot exceed 100%, resulting in continuous consumption of the precursor during use. In general, polymers tend to be more stable than monomer molecules. For example, ethylene and styrene may be polymerized to generate a more structurally stable polyethylene or polystyrene. Thus, the inventors propose polymerizing indole to generate pind, so as to retain the property of photoionization to generate hydrated electrons, and at the same time, to have structural stability, thereby continuously and stably generating the hydrated electrons. Indole may be polymerized to generate pind, with polymerization occurring primarily at positions 2 and 3 without destroying the indole structure. Currently, there are few studies on photochemical properties of pind, and whether pind can generate hydrated electrons under light is unknown. Pind was synthesized by a chemical oxidation method in an aqueous solution, and the degradation of PFASs through photo-generated hydrated electron of pind was studied. It was found for the first time that pind may generate hydrated electrons under ultraviolet irradiation and degrade PFASs. Repeated experiments show that pind is stable in structure and may continuously generate hydrated electrons, and the yield of the hydrated electrons exceeds 100%. It is proved that polymerizing indole to generate pind not only retains the ability of the photoionization of indole units to generate the hydrated electrons, but also increases the stability of a molecular structure through a highly conjugated structure formed after polymerization so that pind has the ability of continuously and stably generating hydrated electrons and exceeds the theoretical upper limit of the yield of the hydrated electrons.

Preferably, the polymerizing indole to synthesize pind includes the steps of:

weighing ferric chloride, and then dissolving into an acetonitrile solution to form a ferric chloride solution; weighing indole, and then dissolving into an acetonitrile solution to form an indole solution; and

adding the indole solution dropwise to the ferric chloride solution under a nitrogen atmosphere, followed by shaking, and then filtering to obtain pind particles; washing the pind particles repeatedly with an organic solvent and water to remove impurities, and then performing vacuum drying and sieving to obtain pind.

In the above-mentioned solution, indole monomers are subjected to oxidative polymerization using a chemical oxidation method under the action of a ferric chloride oxidant to generate pind, so as to retain the property of photoionization to generate hydrated electrons, and at the same time, to have structural stability, thereby continuously and stably generating the hydrated electrons.

Preferably, a molar concentration of the ferric chloride solution is 0.6-0.7 mol/L.

In the above-mentioned solution, limiting the molar concentration of the ferric chloride solution within a reasonable range of values is beneficial to increase the efficiency of the polymerization reaction.

Preferably, a molar concentration of the indole solution is 0.4-0.6 mol/L.

In the above-mentioned solution, limiting the molar concentration of the indole solution within a reasonable range of values is beneficial to increase the efficiency of the polymerization reaction.

Preferably, the shaking has a rotation speed of 100-300 rpm and a time of 10-14 h; preferably, the shaking has a rotation speed of 200 rpm and a time of 12 h; and/or the filtering refers to filtering through a 0.22 μm organic filter membrane by vacuum filtration.

In the above-mentioned solution, limiting the rotation speed and time of the shaking within a reasonable range of values is beneficial to a sufficient polymerization reaction, and reasonably limiting a manner of the filtering may effectively collect the pind particles.

Preferably, the organic solvent is methanol, and the water is hot water at 50° C.; and/or the vacuum drying is performed at 60° C. for 12 h.

In the above-mentioned solution, impurities on the pind particles may be sufficiently washed away by selecting an appropriate type of washing solvent to improve the product purity. High-quality drying may be achieved by limiting the vacuum drying conditions.

Preferably, the mixing synthesized pind with the PFAS to form a mixed solution, and illuminating the formed mixed solution to allow pind to generate hydrated electrons for degrading the PFAS includes the steps of:

preparing a PFAS aqueous solution; and

dispersing synthesized pind in the prepared PFAS aqueous solution, adjusting a pH value to 5.0-7.0, and then stirring evenly to form the mixed solution; immersing a low-pressure mercury lamp in the mixed solution, and turning on the lamp for a degradation reaction.

In the above-mentioned solution, structurally stable pind is subjected to ultraviolet irradiation to generate hydrated electrons and degrade PFASs. In addition, pind is stable in structure and may continuously generate the hydrated electrons, and the yield of the hydrated electrons exceeds 100%.

Preferably, the degradation reaction system is an open system and is not subjected to an air isolation treatment.

In the above-mentioned solution, the degradation reaction system is the open system and is not subjected to the air isolation treatment so that the degradation conditions are simple and not harsh.

Preferably, a temperature of the degradation reaction is controlled at 25±1° C., and a reaction time is 1-6 h; a light source is a 36 W low-pressure mercury lamp, and a wavelength of light emitted from the light source is mainly concentrated at 254 nm.

In the above-mentioned solution, the degradation efficiency may be improved by rationally selecting the temperature, time, and light source of the degradation reaction.

Preferably, in the mixed solution, a weight ratio of pind to the PFAS is (50-500): 1, and water used in the reaction is ultrapure water. Preferably, in the mixed solution, a concentration of the PFAS is 2 mg/L.

In the above-mentioned solution, pind may degrade the PFAS more effectively by limiting the contents of pind and the PFAS in the mixed solution to improve the degradation efficiency.

According to the degradation method of a PFAS of the present disclosure, indole with a high yield of hydrated electrons is polymerized to generate pind, and pind is used as a precursor for the generation of the hydrated electrons to increase the stability of the molecular structure of pind through the highly conjugated structure formed after polymerization, thereby achieving the purpose of continuously generating the hydrated electrons under ultraviolet irradiation and effectively degrading the PFASs. The present disclosure has for the first time found that pind may continuously generate hydrated electrons and then degrade PFASs. The beneficial effect thereof is to form a new method capable of continuously generating hydrated electrons and effectively degrading PFASs, which is of great significance for addressing the environmental pollution problem of PFASs.

### BRIEF DESCRIPTION OF DRAWINGS

FIG. 1 is an infrared spectrum of pind obtained in example 1 of the present disclosure;

FIG. 2 is an electron paramagnetic resonance (EPR) spectrum of sample systems with and without the addition of pind according to example 1 of the present disclosure;

FIG. 3 is a graph comparing degradation rates in degradation methods of simply using ultraviolet irradiation and after adding pind according to example 1 of the present disclosure;

FIG. 4 is a graph comparing defluorination rates in degradation methods of simply using ultraviolet irradiation and after adding pind according to example 1 of the present disclosure;

FIG. 5 is a graph of degradation rates in repeat experiments of a degradation method after adding pind according to example 1 of the present disclosure;

FIG. 6 is a graph of defluorination rates in repeat experiments of a degradation method after adding pind according to example 1 of the present disclosure;

FIG. 7 is a graph comparing degradation rates of PFOA at different weight ratios of pind and PFOA according to example 2 of the present disclosure; and

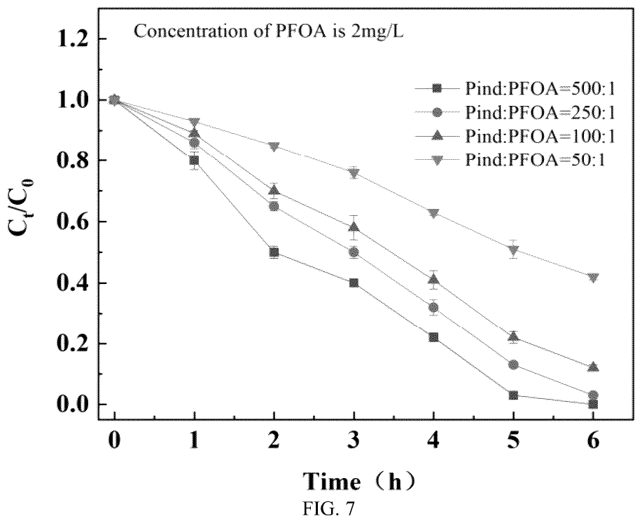

FIG. 8 is a graph comparing defluorination rates of PFOA at different weight ratios of pind and PFOA according to example 2 of the present disclosure.

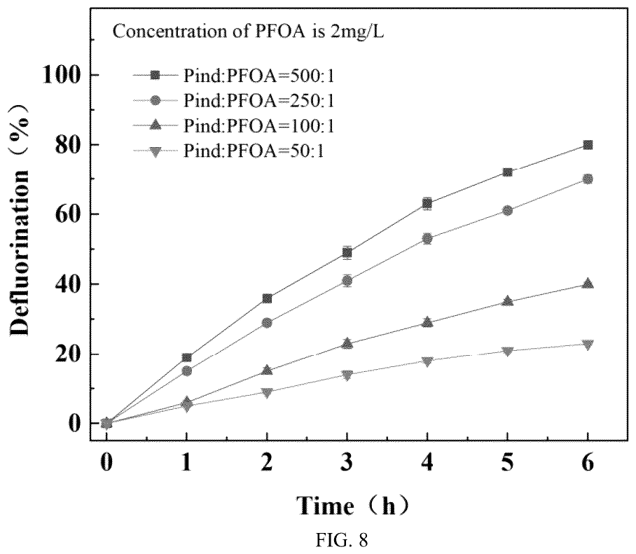

### DETAILED DESCRIPTION OF THE EMBODIMENTS

### Example 1

A degradation method of a PFAS is provided, including the following steps.

Preparation and characterization of pind: a reaction formula for polymerizing indole to generate pind was as follows.

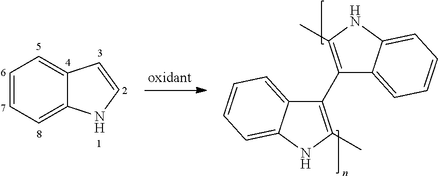

70 mL of acetonitrile was placed into a three-neck flask, and then 0.046 mol ferric chloride was slowly added and dissolved with thorough stirring. Then, 30 mL of acetonitrile solution with 0.015 mol indole dissolved in was added dropwise under a nitrogen atmosphere. The mixed solution was shaken at 200 rpm for 12 hours. The shaken solution was filtered through a 0.22 um organic filter membrane by vacuum filtration to retain pind particles on the filter membrane. The pind particles were washed repeatedly with methanol and 50° C. hot water to remove impurities. Then, vacuum drying was performed at 60°° C. for 12 h. Finally, pind was ground using an agate mortar and sieved through a 100-mesh sieve to obtain a pind sample.

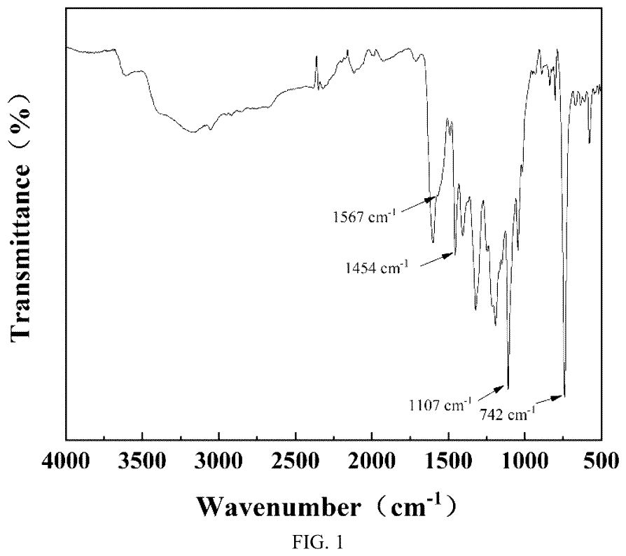

Prepared pind was characterized by infrared (FIG. 1) and compared with an infrared spectrum of pind reported in the literature. The stretching vibration of a benzene ring structure of pind was observed at 1454 cm⁻¹, 1209 cm⁻¹, and 1107 cm⁻¹, proving that pind was successfully synthesized. The vibration of the N—H bond was observed at 1567 cm⁻¹, indicating that the N—H structure at position 1 was not destroyed after polymerization. Meanwhile, peak positions of 721 cm⁻¹ and 767 cm⁻¹, which belong to the out-of-plane deformation vibration of C2-H and C3-H, respectively, were observed to disappear, and a peak position of 742 cm⁻¹ was replaced, proving that the polymerization mainly occurred at positions 2 and 3 of indole.

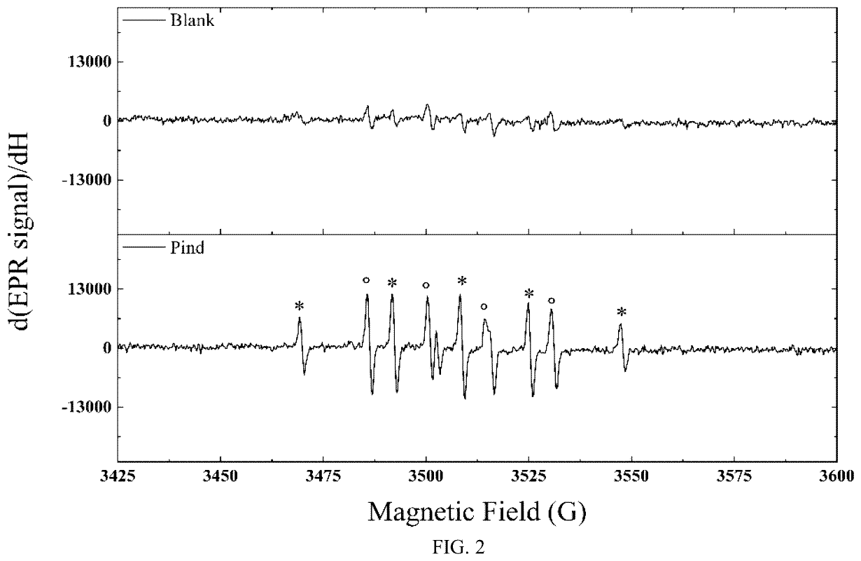

The determination of hydrated electrons included the following steps. Pind was first dispersed in an aqueous solution and then transferred to a 15 mL cylindrical quartz reaction tube, and the pH of the solution was adjusted to 6.0 using 0.1 M NaOH and HCl, and then a hydrated electron trapping agent dimethylpyridine N-oxide (DMPO) was added. A total reaction volume was 10 mL with contents of pind and DMPO were 2.0 g/L and 100 mM, respectively. After irradiating the above prepared sample with a mercury lamp for 1.5 minutes, 25 μL of sample was sampled with a quartz capillary tube and placed into a resonant cavity of an EPR instrument to detect a radical signal. It was found from the experimental results (FIG. 2) that only a very small amount of radical signal could be detected in the system without the addition of pind, and a strong hydrated electron signal was detected in the sample after the addition of pind, proving that pind generated hydrated electrons under ultraviolet irradiation. In addition to the hydrated electron signal, a strong hydroxyl radical signal was also detected, which was mainly because the hydrated electrons could react with surrounding O₂ and H⁺ to generate hydroxyl radicals. Since the reaction system could not completely isolate O₂, some hydrated electrons were converted into hydroxyl radicals. Circles in the figure indicated EPR signals of hydroxyl radicals, and asterisks indicated EPR signals of the hydrated electrons.

Photochemical degradation reaction: before performing the degradation reaction, a 2 mg/L PFOA aqueous solution was first prepared, and then pind was dispersed in the PFOA aqueous solution. The pH of the solution was adjusted to 6.0 using 0.1 M NaOH and HCl, and the prepared reaction solution was stirred for 0.5 h using magnetic stirring to form a mixed solution. The prepared mixed solution was transferred into a cylindrical quartz glass reactor, and a low-pressure mercury lamp was immersed into the reaction solution in an open environment and then turned on for the degradation reaction. A reaction volume was 200 mL, a reaction temperature was controlled at 25+1° C., and a reaction time was 6 h. A light source was a 36 W low-pressure mercury lamp (a wavelength of light emitted from the light source was mainly concentrated at 254 nm). The contents of pind and PFOA in the reaction solution were 0.5 g/L and 2 mg/L, respectively. 2 mL samples were taken every hour, and the samples were divided into two parts. One part was extracted with 2 volumes of methanol, and then the residual content of PFOA was detected by high performance liquid chromatography mass spectrometry (HPLC-MS/MS) to calculate a degradation rate of PFOA. The other part was added with 2 volumes of pure water and vortexed for 1 minute, and then filtered with a 0.22 μm aqueous phase filter membrane. Then, the content of generated F ions was measured by ion chromatography (IC) to calculate a defluorination rate of PFOA.

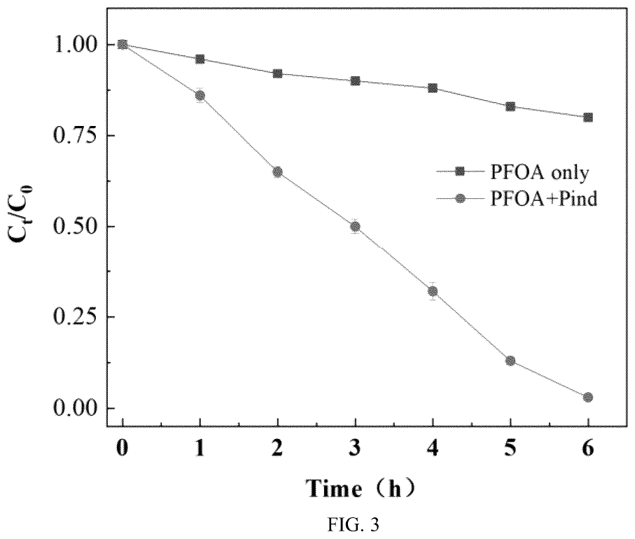

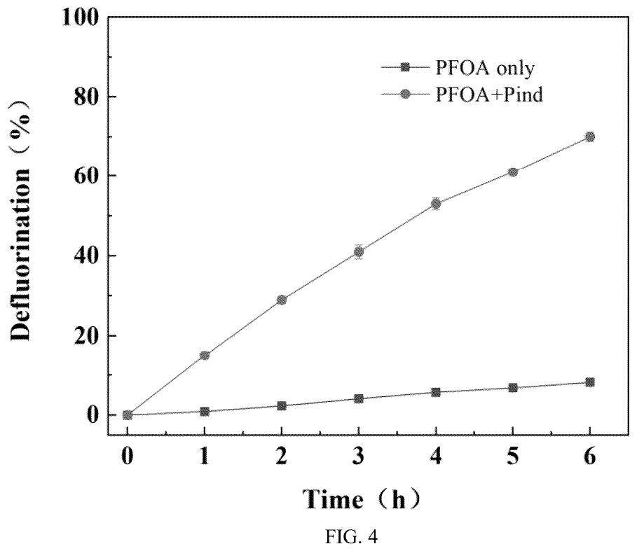

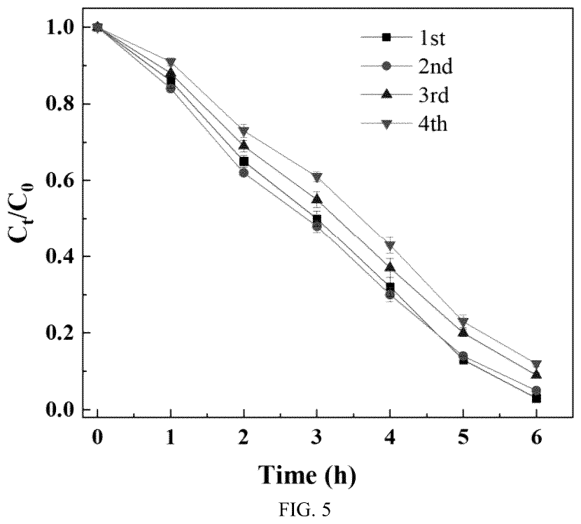

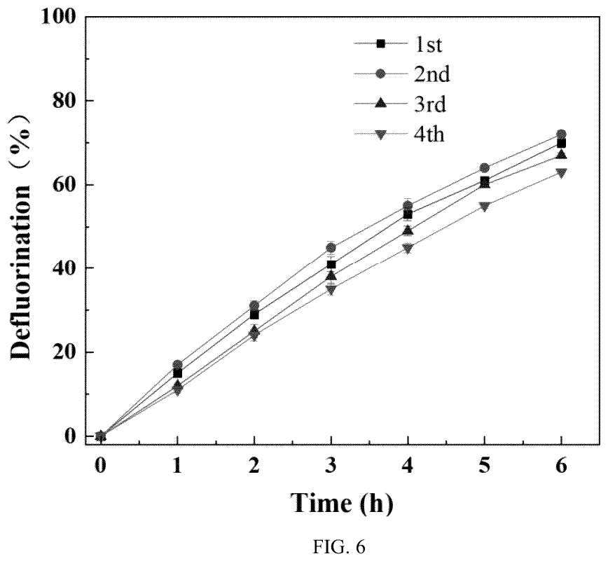

It could be seen from the experimental results (FIGS. 3 and 4) that the degradation rate of PFOA was about 20%, and the defluorination rate was about 8% after reaction for 6 h using the method of simply using ultraviolet irradiation. After adding pind, the degradation of PFOA was greatly promoted. PFOA could be completely degraded after reaction for 6 h, and the defluorination rate was close to 70%. The reaction system was an open system without an air isolation treatment. The experimental results showed that pind could efficiently degrade PFOA by generating hydrated electrons under ultraviolet irradiation. Four repeated experiments were performed, and as shown in the results of FIGS. 5 and 6, pind showed no significant decrease in the degradation and defluorination efficiency of PFOA, indicating that pind was very stable in the reaction and could continuously and stably generate the hydrated electrons and efficiently degrade PFOA. According to previous studies, there were 15 C—F bonds in a PFOA molecule, and it was conservatively estimated that about 50% of the C—F bond breakage was caused by the direct attack of the hydrated electrons. An amount of PFOA used in the experiments of the present disclosure was 2 mg/L. After calculation, a yield of the hydrated electrons of indole units in pind after four repeated experiments was about 200%, i.e., at least 2 hydrated electrons were generated per indole unit. After one indole molecule generated one hydrated electron, the structure of the indole molecule changed, and it was difficult to generate hydrated electrons again, so the yield of the hydrated electrons did not exceed 100%. It showed that a polymeric structure allowed pind to break through an upper limit of the yield of the hydrated electrons of single molecule indole, giving pind the ability to continuously generate the hydrated electrons.

### Example 2

In the example, changes in the degradation and defluorination rates of PFOA at different weight ratios of pind and PFOA were studied. Four weight ratios were set, i.e., weight ratios of pind: PFOA were 500:1, 250:1, 100:1, and 50:1. The concentration of PFOA was constant and controlled to be 2 mg/L. Other reaction conditions were the same as those in the photochemical degradation reaction in example 1.

What is claimed is:

1. A degradation method of a perfluoroalkyl substance (PFAS), comprising the following steps:
polymerizing indole to synthesize pind; and
mixing synthesized pind with the PFAS to form a mixed solution, and illuminating the formed mixed solution to allow pind to generate hydrated electrons (e_{aq}⁻) for degrading the PFAS.

2. The degradation method according to claim 1, wherein the polymerizing indole to synthesize pind comprises the steps of:
weighing ferric chloride, and then dissolving into an acetonitrile solution to form a ferric chloride solution; weighing indole, and then dissolving into an acetonitrile solution to form an indole solution; and
adding the indole solution dropwise to the ferric chloride solution under a nitrogen atmosphere, followed by shaking, and then filtering to obtain pind particles; washing the pind particles repeatedly with an organic solvent and water to remove impurities, and then performing vacuum drying and sieving to obtain pind.

3. The degradation method according to claim 2, wherein a molar concentration of the ferric chloride solution is 0.6-0.7 mol/L.

4. The degradation method according to claim 2, wherein a molar concentration of the indole solution is 0.4-0.6 mol/L.

5. The degradation method according to claim 2, wherein the shaking has a rotation speed of 100-300 rpm and a time of 10-14 h; preferably, the shaking has a rotation speed of 200 rpm and a time of 12 h; and/or the filtering refers to filtering through a 0.22 μm organic filter membrane by vacuum filtration.

6. The degradation method according to claim 2, wherein the organic solvent is methanol, and the water is hot water at 50° C.; and/or the vacuum drying is performed at 60° C. for 12 h.

7. The degradation method according to claim 1, wherein the mixing synthesized pind with the PFAS to form a mixed solution, and illuminating the formed mixed solution to allow pind to generate hydrated electrons for degrading the PFAS comprises the steps of:
preparing a PFAS aqueous solution; and
dispersing synthesized pind in the prepared PFAS aqueous solution, adjusting a pH value to 5.0-7.0, and then stirring evenly to form the mixed solution; immersing a low-pressure mercury lamp in the mixed solution, and turning on the lamp for a degradation reaction.

8. The degradation method according to claim 7, wherein the degradation reaction system is an open system and is not subjected to an air isolation treatment.

9. The degradation method according to claim 7, wherein a temperature of the degradation reaction is controlled at 25±1° C., and a reaction time is 1-6 h; a light source is a 36 W low-pressure mercury lamp, and a wavelength of light emitted from the light source is mainly concentrated at 254 nm.

10. The degradation method according to claim 7, wherein in the mixed solution, a weight ratio of pind to the PFAS is (50-500): 1, and water used in the reaction is ultrapure water;
preferably, in the mixed solution, a concentration of the PFAS is 2 mg/L.
